(19) United States
(12) Patent Application Publication
(10) Pub. No.: US 2014/0355421 A1
(43) Pub. Date: Dec. 4, 2014

(54) Link Aggregation Control Protocol (LACP) Loop Detection

(71) Applicant: Hangzhou H3C Technologies Co., LTD., Hangzhou (CN)

(72) Inventors: Shengyan Zhang, Beijing (CN); Yixiu Luo, Beijing (CN)

(73) Assignee: Hangzhou H3C Technologies Co., LTD., Hangzhou (CN)

(21) Appl. No.: 14/222,680

(22) Filed: Mar. 24, 2014

(30) Foreign Application Priority Data
May 31, 2013 (CN) 201310215309.8

(51) Int. Cl. H04L 12/24; H04L 12/705; H04L 12/26

(52) U.S. Cl. CPC H04L 41/0654; H04L 43/50; H04L 45/18
USPC 370/225

(57) ABSTRACT

Link Aggregation Control Protocol (LACP) loop detection in a network that includes a Software Defined Networking (SDN) controller, a server and an edge switch is provided. The server virtualizes a virtual switch and virtual machines. The virtual switch includes uplink ports that are aggregated with downlink ports of the edge switch to form an aggregation group, and the SDN controller controls operation of the virtual switch. The virtual switch periodically sends a LACP data unit (LACPDU) message to the edge switch via each of the uplink ports in the aggregation group. The virtual switch receives a LACPDU message from the edge switch via one of the uplink ports in the aggregation group. When it is determined that the received LACPDU message originates from the virtual switch itself, the virtual switch keeping one of the uplink ports running and shutting down the rest of the uplink ports.

### CROSS-REFERENCE TO RELATED APPLICATIONS

This application claims priority to CN Patent Application No. 201310215309.8, filed on May 31, 2013, entitled “A Kind of LACP Loop Detection Method and Device Based on an Open Flow Protocol,” which is incorporated herein by reference.

### BACKGROUND

As user demand for data center services grows, data centers have functions that are increasingly complex and difficult to manage. To reduce management cost and meet higher service requirements, data centers have been integrated and their resources virtualized. Virtualization abstracts physical resources and services provided by data centers from resource users and system managers to reduce the complexity of resource utilization and management and increase resource utilization efficiency. For example, data center virtualization may be used to increase central processing unit (CPU) utilization rate and shared storage capacity as well as to reduce system energy consumption and the costs for system design, operation, management and maintenance.

Data center virtualization generally includes several aspects, including network virtualization, storage virtualization and server virtualization. Using virtualization software (e.g. VMWare software), a physical server may be virtualized into multiple virtual machines (VMs) that operate independently of each other. Each VM has its own operating system, applications and virtual hardware environment, such as virtual central processing unit (CPU), memory, storage device, input/output (IO) device, virtual switch, etc.

Edge Virtual Bridging (EVB) technologies may be applied to virtual switches and servers in the network to simplify various functions, e.g. traffic forwarding by virtual servers, controlling of network switches, centralized traffic management and strategy of virtual servers and virtual migration, etc. Virtual switches that support EVB includes Virtual Ethernet Bridge (VEB) and Virtual Edge Port Aggregator (VEPA) switches.

### BRIEF DESCRIPTION OF DRAWINGS

By way of non-limiting examples, the present disclosure will be described with reference to the following drawings, in which:

FIG. 1 is a flowchart of a process for Link Aggregation Control Protocol (LACP) loop detection , according to examples of the present disclosure.

FIG. 2 is a schematic diagram of a network in which LACP loop detection may be implemented, according to examples of the present disclosure;

FIG. 3 is a flowchart of a process for LACP loop detection using extended LACP data unit (LACPDU) messages, according to examples of the present disclosure;

FIG. 4 is a schematic diagram of a structure of a network device capable of acting as a server that virtualizes a virtual switch and virtual machines, according to examples of the present disclosure; and

FIG. 5 is a schematic diagram of modules of a network device capable of acting as a server that virtualizes a virtual switch and virtual machines, according to examples of the present disclosure.

### DETAILED DESCRIPTION

A physical or virtual network device, such as a virtual switch, etc., generally includes a control plane that decides how traffic is forwarded and a data plane that implements how traffic is forwarded. Software defined networking (SDN) is an approach that logically separates the control plane and the data plane, such that they may be handled by different devices etc. For example, a virtual switch enabled with SDN includes a flow table and forwards traffic flows based on the flow table. An SDN controller acts as the control plane and carries higher level control functions.

LACP allows aggregation of physical ports of a virtual switch to form a single logical channel. For example, multiple ports of the virtual switch may be aggregated with ports of an edge switch to increase throughput and provide redundancy. However, when there is a failure at the virtual switch or a flow table issued by an SDN controller to the virtual switch is faulty, a loop may occur between ports of the virtual switch and ports of the edge switch.

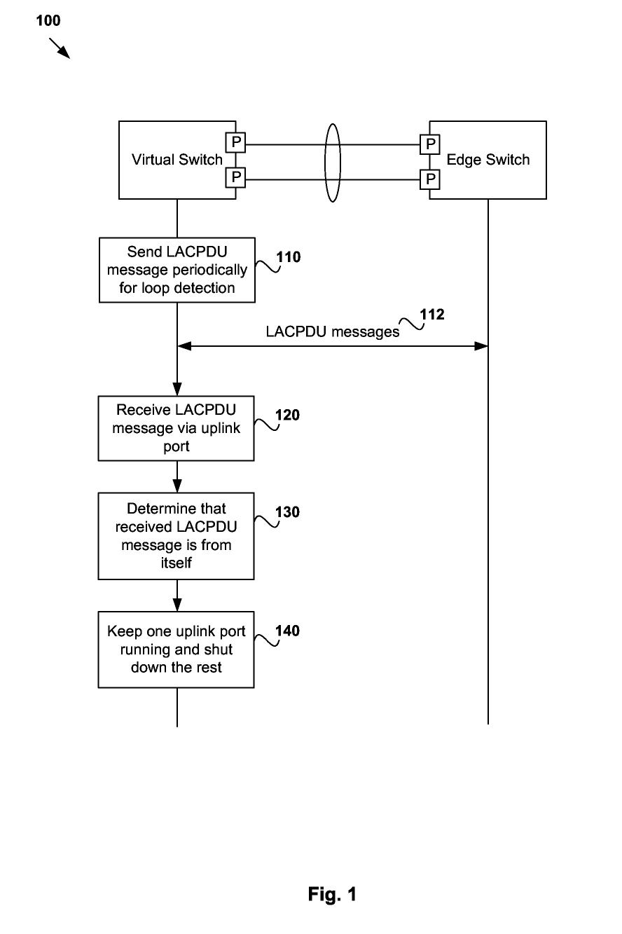

According to examples of the present disclosure and referring to FIG. 1, a LACP loop detection process 100 is provided. The process 100 is applicable to a network that includes an SDN controller, a server and an edge switch. The server virtualizes a plurality of virtual machines and a virtual switch that includes a plurality of uplink ports aggregated with a plurality of downlink ports of the edge switch to form an aggregation group. The SDN controller controls operation of the virtual switch.
At 110 in FIG. 1, the virtual switch sends a LACP data unit (LACPDU) message 112 to the edge switch periodically via each of the plurality of uplink ports in the aggregation group.
At 120, the virtual switch receives a LACPDU message 112 from the edge switch via one of the plurality of uplink ports in the aggregation group.
At 130 and 140, when the virtual switch determines that the received LACPDU message 112 originates from the virtual switch itself, the virtual switch keeps one of the plurality of uplink ports running and shuts down the rest of the plurality of uplink ports.

According to examples of the present disclosure, LACPDU messages are periodically sent by the virtual switch to the edge switch for loop detection. LACPDU messages, which are generally used for exchanging link aggregation information, are also used for loop detection to save on network resources. For example, instead of generating a different type of messages, the use of LACPDU messages for loop detection does not changes to the underlying system to process new messages and extra resources to send additional messages.

When a LACP loop is detected (i.e. virtual switch receiving LACPDU message that originates from the virtual switch itself), all but one uplink port at the virtual switch are shut down to break the loop. This avoids or reduces the likelihood of the loop causing out-of-order traffic forwarding and operational abnormalities at the virtual switch and server. In some cases, a network paralysis caused by the loop may be avoided or the likelihood of its occurrence reduced.

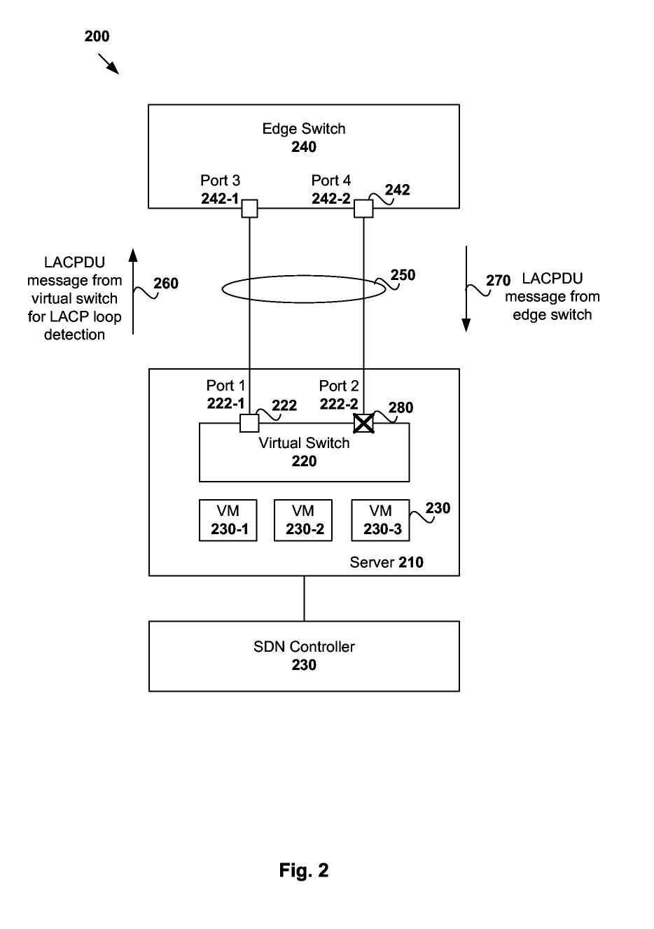

FIG. 2 illustrates a network 200 in which LACP loop detection may be implemented, according to examples of the present disclosure. Network 200 includes server 210 that is virtualized into virtual switch 220 and multiple virtual machines 230-1, 230-2 and 230-3. Virtual switch 220 includes multiple uplink ports, such as ports 222-1 (“Port 1”) and 222-2 (“Port 2”) etc. Port 1 and port 2 are collectively referred to as “uplink ports 222” or individually as a generic “uplink port 222.” Similarly, virtual machines 230-1, 230-2 and 230-3 are collectively referred to as “virtual machines 230” or individually as a generic “virtual machine 230.”

SDN controller 232 is connected to server 210 and controls operation of virtual switch 220. SDN controller 232 issues a flow table to virtual switch 220, which generally includes header fields, action counter fields, and (if any) action fields. A traffic flow is a stream of packets carrying data from a source to a destination. When a packet is received, the relevant action is taken by virtual switch 220 if header fields of the packet match corresponding fields in the flow table. Otherwise, the packet is forwarded to the SDN controller 232 to decide on an appropriate action. Entries in the flow table are added, deleted or modified based on instructions from SDN controller 232 via a secure channel.

Any suitable SDN protocol may be used in network 200, such as OpenFlow, etc. OpenFlow, which is gaining acceptance in the marketplace, is a network technology invented by Stanford University that allows separation of control and data plane and enables conventional layer 2 and layer 3 forwarding devices to have fine-granularity flow forwarding capabilities. Using OpenFlow, a conventional MAC-based and IP-based forwarding may be expanded into flow forwarding based on header information of multi-domain network packets.

Besides OpenFlow, other suitable technique may be used depending on network 200 in practice, including CLIs (Command-line Interfaces); SNMP (Simple

Network Management Protocol); XMPP (Extensible Messaging and Presence Protocol); NETCONF (Network Configuration Protocol); OpenStack; virtualization software APIs (Application Programming Interfaces); OF-Config (Open Flow Management and Configuration Protocol); and Secure Shell (SSH), etc.

Virtual switch 220 may implement any suitable virtual switching technology, such as Virtual Edge Port Aggregator (VEPA), etc. In general, VEPA switch 220 forwards all network traffic generated by virtual machines 230 to edge switch 240 connected to server 210, including traffic between virtual machines 230 on the same server 210. Besides traffic forwarding, VEPA also facilitates monitoring of virtual machine traffic and implements a virtual machine access layer on a server access management system.

Edge switch 240 includes multiple downlink ports, such as ports 242-1 (“Port 3”) and 242-2 (“Port 4”), etc. They are collectively referred to as “downlink ports 242” or individually as a generic “downlink port 242.” LACP facilitates link aggregation. In network 200, uplink ports 222 of virtual switch 220 are aggregated with downlink ports 242 of edge switch 240 to form an aggregation group 250 (also known as link aggregation group, LAG).

According to examples of the present disclosure in FIG. 1, virtual switch 220 sends LACPDU messages periodically to edge switch 240 for loop detection (also generally indicated at 260 in FIG. 2). LACPDU messages are generally sent by virtual switch 220 to announce link aggregation information to edge switch 240 but for efficiency, they are also used for loop detection in network 200.

When links between virtual switch 220 and edge switch 240 are working normally, LACPDU messages are processed and terminated by the recipient without returning them to the sender. However, when virtual switch 220 receives LACPDU messages sent by itself (generally indicated at 270 in FIG. 2), this indicates that a loop occurs between virtual switch 220 and edge switch 240. For example, LACPDU messages are sent by virtual switch 220 via Port 1 to Port 3 on edge switch 240.

When there is a loop, the LACPDU messages sent by virtual switch 220 are also received via Port 2 from Port 4 on edge switch 240. If this continues, the loop causes traffic forwarding problems between virtual switch 220 and edge switch 240. After the loop is detected, one of the uplink ports 222 (e.g. Port 1) is kept running while the remaining (e.g. Port 2) are shut down or disabled (generally indicated at 280 in FIG. 2).

Extended LACPDU Messages

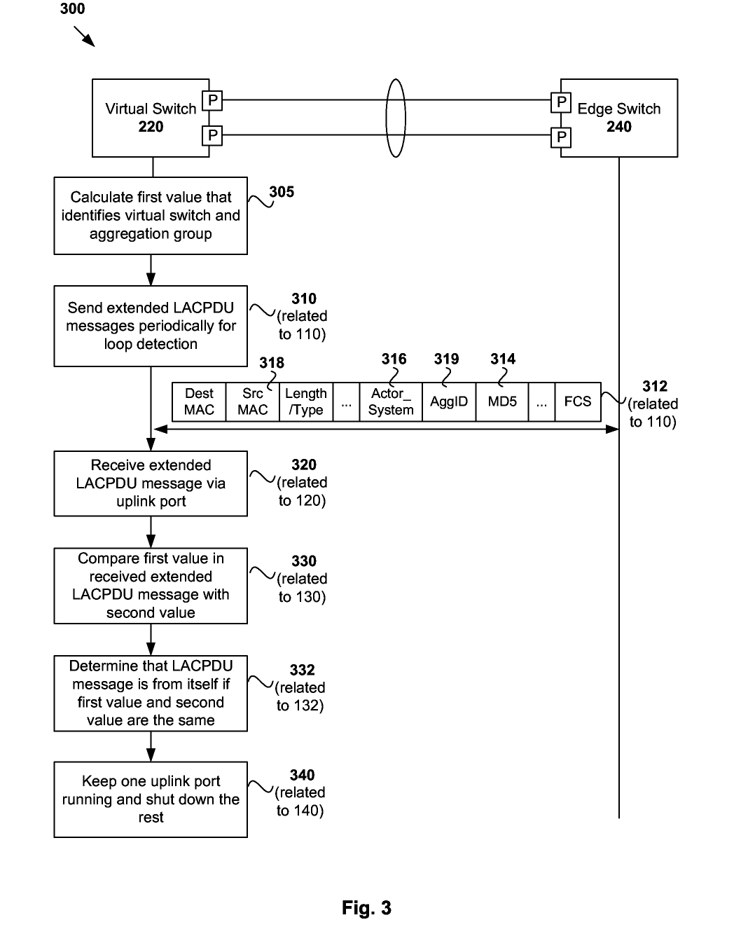

FIG. 3 is a flowchart of a process 300 for LACP loop detection using extended LACPDU messages, according to examples of the present disclosure. Although extended LACPDU messages are used in FIG. 3, it should be understood that loop detection using LACPDU messages may be implemented using any suitable approach that allows virtual switch 220 to determine that it is receiving LACPDU messages originating from itself.

At 305 in FIG. 3, virtual switch 220 calculates a value (“first value”) that allows virtual switch 220 to determine that a received LACPDU message originates from itself. Any suitable algorithm may be used to calculate the first value to identify virtual switch 220 and uplink ports 222 in aggregation group 250. For example, a cryptographic hash function such as message-digest algorithm MD5 may be used. MD5 is an irreversible string transformation algorithm which makes it difficult, if not impossible, to crack or decrypt. An MD5 hash value may be calculated based system identifier (ID) of virtual switch 220, source media access control (MAC) address associated with uplink ports 222 of virtual switch 220 and aggregation ID of aggregation group 250.

At 310 in FIG. 3 (related to 110 in FIG. 1), virtual switch 220 periodically sends extended LACPDU messages carrying the calculated value to edge switch 240 for loop detection. Extended LACPDU message 312 carrying the MD5 value 314 is sent by virtual switch 220 via each uplink port 222. In particular, extended LACPDU message 312 includes an extended Type Length Value (TLV) field that carries MD5 value 314.

At 320 in FIG. 3 (related to 120 in FIG. 1), virtual switch 220 receives an LACPDU message via one of its uplink ports 222 in aggregation group 250.

At 330 and 332 in FIG. 3 (related to 130 in FIG. 1), virtual switch 220 determines whether the received LACPDU message originates from itself. Specifically, at 330, if the received LACPDU message carries an extended TLV field 314, virtual switch 220 compares the value of extended TLV field 314 with a value (“second value”) calculated based on the virtual switch's 220 knowledge of its system identifier (ID), source media access control (MAC) address associated with uplink ports 222 and aggregation ID of aggregation group 250. To improve efficiency, the second value may be pre-calculated and reused every time extended LACPDU messages are processed.

If no extended TLV field carrying MD5 value 314 is found in the received LACPDU message, virtual switch 220 may determine the message is not sent by itself for loop detection and processes it as usual based on its content.

Next, at 332 in FIG. 3, if the second value is the same as the first value 314 carried in extended LACPDU message 312, virtual switch 220 determines that the received extended LACPDU message 312 is the extended LACPDU message sent by virtual switch 220 at 310. In other words, a loop between virtual switch 220 and edge switch 240 is detected.

At 340 in FIG. 3, after a loop is detected, virtual switch 220 shuts down all but one of its uplink ports 222 in aggregation group 250. For example in FIG. 2, virtual switch 220 keeps Port 1 running and shuts down the remaining Port 2. When the cause for the loop fault is removed, Port 2 is enabled again to receive and send LACPDU messages as usual.

Although extended LACPDU messages 312 may be used for loop detection according to FIG. 3, it should be understood that any other suitable approach may be used. For example, instead of calculating MD5 values, virtual switch 220 detect a loop based on fields in LACPDU messages 312, including “Actor System” field 316 (i.e. system ID of virtual switch 220), “Src MAC” field 318 (i.e. source MAC address associated with uplink ports 222 in aggregation group 250) and “AggID” field 319 (i.e. aggregation group ID).

However, comparing MD5 values instead of checking each field 316, 318, 319 may be more efficient and less resource intensive in real time because the second value used at 330 in FIG. 3 may be pre-calculated. Also, since MD5 values are difficult to decrypt, they also serve as a security feature to examine integrity of LACPDU message 312. This, for example, avoids inadvertently shutting down all but one uplink port 222 of virtual switch 220.

Example Network Devices 400

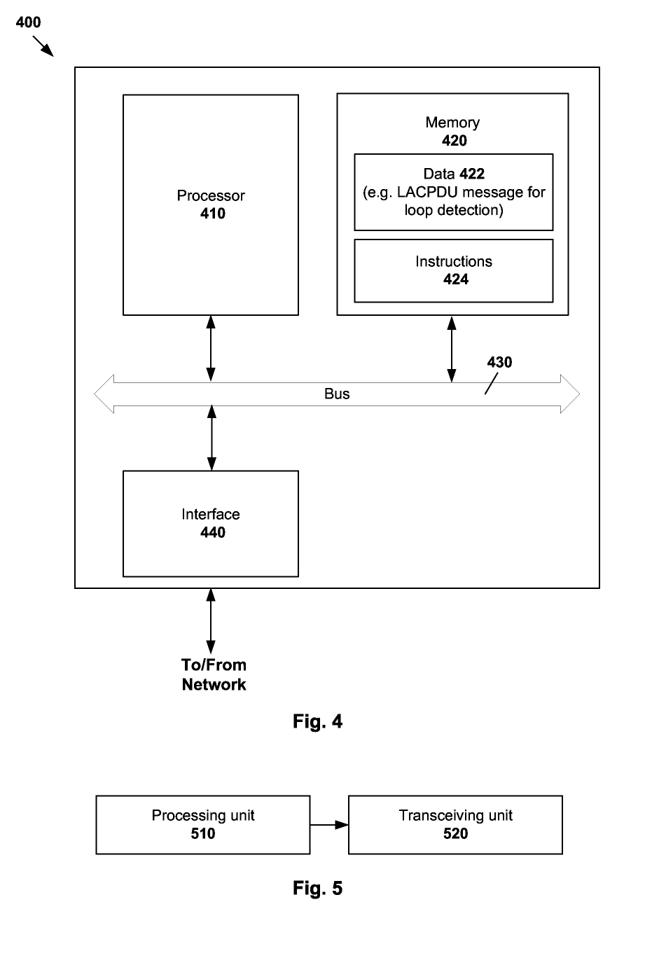

The above examples can be implemented by hardware, software or firmware or a combination thereof. FIG. 4 shows a network device 400 capable of acting as server 210, according to examples of the present disclosure. Network device 400 includes processor 410, memory 420 and interface 440 (e.g. port) that communicate with each other via bus 430.

Processor 410 is to virtualize network device 400 into virtual machines 230 and virtual switch 220 and perform processes described herein with reference to FIG. 1 to FIG. 3. In one example, processor 410 is to implement virtual switch 220 to perform LACP loop detection (e.g., based on Open Flow protocol or any other suitable technique), as follows:
Send a LACP data unit (LACPDU) message to the edge switch via each of the plurality of uplink ports in the aggregation group periodically.
Receive a LACPDU message from the edge switch via one of the plurality of uplink ports in the aggregation group; and
When it is determined that the received LACPDU message is the LACPDU sent by the virtual switch itself, keep one of the plurality of uplink ports running and shut down the rest of the plurality of uplink ports.

Memory 420 may store any necessary data 422 for facilitating implementation of LACP loop detection (e.g., based on Open Flow protocol or any other suitable technique), such as LACPDU messages for loop detection. If MD5 algorithm is used, memory 420 may further store MD5 values for loop detection.

Memory 420 may further store instructions 424 (not shown in FIG. 4 for simplicity) executable by processor 410, such as:
Instructions executable by processor 410 to implement virtual switch 220 to send a LACPDU message to the edge switch via each of the plurality of uplink ports in the aggregation group periodically.
Instructions executable by processor 410 to implement virtual switch 220 to receive a LACPDU message from the edge switch via one of the plurality of uplink ports in the aggregation group; and
Instructions executable by processor 410 to implement virtual switch 220 to, when it is determined that the received LACPDU message is the LACPDU sent by the virtual switch itself, keep one of the plurality of uplink ports running and shut down the rest of the plurality of uplink ports.

As explained according to FIG. 1 to FIG. 3, the LACPDU messages may be extended LACPDU messages that carry a first value (e.g. MD5 hash value) calculated based on system identifier of the virtual switch 220, a source MAC address associated with the plurality of uplink ports 222 in aggregation group 250 and an aggregation group ID of the aggregation group 250.

In some examples of the present disclosure, network device 400 in FIG. 4 may include units (which may be software, hardware or a combination of both) to perform the processes described with reference to FIG. 1 to FIG. 3. FIG. 5 shows transceiving 510 and processing 520 units of network device 400, according to examples of the present disclosure:
Transceiving unit 510 is to send LACPDU messages to the edge switch periodically through each of the uplink ports in the aggregation group and receive the LACPDU messages sent by said edge switch through uplink ports in said aggregation group;
Processing unit 520 is to, when transceiving unit 510 receives the LACPDU messages sent by the edge switch through any uplink port in the aggregation group, if it is determined that the received LACPDU messages are the LACPDU messages sent by said VEPA switch through uplink ports in said aggregation group, keep one of the uplink ports in the aggregation group to work normally and shut down the rest uplink ports.

Although transceiving 510 and processing 520 units are shown in FIG. 5, they may be integrated into a single unit, or further divided into sub-units. The methods, processes and units described herein may be implemented by hardware (including hardware logic circuitry), software or firmware or a combination thereof. The term “processor” is to be interpreted broadly to include a processing unit, ASIC, logic unit, or programmable gate array etc. The processes, methods and functional units may all be performed by the one or more processors 410; reference in this disclosure or the claims to a “processor” should thus be interpreted to mean “one or more processors”. Although one network interface 440 is shown in FIG. 4, network interface device 440 may be split into multiple network interfaces (not shown for simplicity).

Further, the processes, methods and units described in this disclosure may be implemented in the form of a computer software product. The computer software product is stored in a storage medium and comprises a plurality of instructions for making a processor to implement the methods recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

Throughout the present disclosure, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the above-described examples, without departing from the broad general scope of the present disclosure. The present embodiments are, therefore, to be considered in all respects as illustrative and not restrictive.

1. A method of Link Aggregation Control Protocol (LACP) loop detection , the method being applicable in a network that includes a Software Defined Networking (SDN) controller, a server and an edge switch, wherein the server virtualizes a virtual switch and a plurality of virtual machines, the virtual switch includes a plurality of uplink ports that are aggregated with a plurality of downlink ports of the edge switch to form an aggregation group, and the SDN controller controls operation of the virtual switch, the method comprising:
the virtual switch periodically sending a LACP data unit (LACPDU) message to the edge switch via each of the plurality of uplink ports in the aggregation group;
the virtual switch receiving a LACPDU message from the edge switch via one of the plurality of uplink ports in the aggregation group; and
when it is determined that the received LACPDU message originates from the virtual switch itself, the virtual switch keeping one of the plurality of uplink ports running and shutting down the rest of the plurality of uplink ports.

2. The method of claim 1, wherein:
the LACPDU message sent to the edge switch includes a system identifier (ID) of the virtual switch, a source MAC address associated with the plurality of uplink ports in the aggregation group and an aggregation group ID of the aggregation group; and
the virtual switch determines that the received LACPDU message originates from the virtual switch itself based on the system ID, source MAC address and aggregation group ID.

3. The method of claim 2, wherein:
the LACPDU message sent to the edge switch includes a first value calculated based on the system ID, source MAC address and aggregation group ID; and
the virtual switch determines that the received LACPDU message originates from the virtual switch itself if the first value in the received LACPDU message is the same as a second value calculated based on the system ID, source MAC address and aggregation group ID.

4. The method of claim 3, wherein the first value and second value are calculated using message-digest algorithm MD5.

5. The method of claim 3, wherein the LACPDU message sent to the edge switch and the LACPDU message received from the edge switch are extended LACPDU messages, and the first value is carried in an extended Type Length Value (TLV) in the extended LACPDU messages.

6. The method of claim 5, wherein the method further comprises:
when it is determined that the received LACPDU message does not originate from the virtual switch, processing the received LACPDU message according to its content.

7. The method of claim 1, wherein the virtual switch is a Virtual Edge Port Aggregator (VEPA) switch, or the SDN controller is an OpenFlow controller, or both.

8. A network device for Link Aggregation Control Protocol (LACP) loop detection, wherein the network device is capable of acting as a server,
wherein the server virtualizes a virtual switch and a plurality of virtual machines, the virtual switch includes a plurality of uplink ports that are aggregated with a plurality of downlink ports of an edge switch to form an aggregation group and a Software Defined Networking (SDN) controller controls operation of the virtual switch,
wherein the network device comprises interface to communicate with the SDN controller and edge switch, memory storing executable instructions, and a processor to execute instructions to implement the virtual switch to:
send a LACP data unit (LACPDU) message to the edge switch via each of the plurality of uplink ports in the aggregation group periodically;
receive a LACPDU message from the edge switch via one of the plurality of uplink ports in the aggregation group; and
when it is determined that the received LACPDU message is the LACPDU sent by the virtual switch itself, keep one of the plurality of uplink ports running and shut down the rest of the plurality of uplink ports.

9. The network device of claim 8, wherein:
the LACPDU message sent to the edge switch includes a system identifier (ID) of the virtual switch, a source MAC address associated with the plurality of uplink ports in the aggregation group and an aggregation group ID of the aggregation group; and
the virtual switch is to determine that the received LACPDU message originates from the virtual switch itself based on the system ID, source MAC address and aggregation group ID.

10. The network device of claim 9, wherein:
the LACPDU message sent to the edge switch includes a first value calculated based on the system ID, source MAC address and aggregation group ID; and
the virtual switch is to determine that the received LACPDU message originates from the virtual switch itself if the first value in the received LACPDU message is the same as a second value calculated based on the system ID, source MAC address and aggregation group ID.

11. The network device of claim 10, wherein the first value and second value are calculated using message-digest algorithm MD5.

12. The network device of claim 10, wherein the LACPDU message sent to the edge switch and the LACPDU message received from the edge switch are extended LACPDU messages, and the first value is carried in an extended Type Length Value (TLV) in the extended LACPDU messages.

13. The network device of claim 12, wherein the method further comprises:
when it is determined that the received LACPDU message does not originate from the virtual switch, the virtual switch is to process the received LACPDU message according to its content.

14. The network device of claim 8, wherein the virtual switch is a Virtual Edge Port Aggregator (VEPA) switch or the SDN controller is an OpenFlow controller, or both.

15. A non-transitory computer readable medium encoded with executable instructions for execution by a processor of a server that implements a virtual switch, wherein the virtual switch is managed by a Software Defined Networking (SDN) controller and the processor is to execute the instructions to:
periodically send a LACP data unit (LACPDU) message to an edge switch via uplink ports aggregated with downlink ports of the edge switch in an aggregation group;
receive a LACPDU message from the edge switch via one of the uplink ports in the aggregation group; and
when it is determined that the received LACPDU message is the LACPDU sent by the virtual switch itself, keep one of the uplink ports running and shut down the rest of the uplink ports.
